(19) United States
(12) Patent Application Publication
(10) Pub. No.: US 2009/0295179 A1
(43) Pub. Date: Dec. 3, 2009

(54) TIRE LIFTING MECHANISM

(76) Inventor: Leonard L. Michaels, Rossford, OH (US)

Correspondence Address: FRASER CLEMENS MARTIN & MILLER LLC, 28366 KENSINGTON LANE, PERRYSBURG, OH, 43551, US

(21) Appl. No.: 12/474,695

(22) Filed: May 29, 2009

Related U.S. Application Data
(60) Provisional application No. 61/057,729, filed on May 30, 2008.

(51) Int. Cl. B66C 1/54

(52) U.S. Cl. 294/97

(57) ABSTRACT

A tire lifting mechanism is disclosed. The tire lifting mechanism includes a frame having a lower plate and a spaced apart upper plate assembly with at least one tube disposed therebetween. A plurality of extendable arms is pivotally attached to the frame. A movable plate and cooperating screw mechanism is provided to move the arms to and from an extended position to engage an associated tire adjacent a bead area thereof. An upward movement of the frame in respect of a supporting surface causes the tire to be centered and lifted from the supporting surface and suspended from the arms of the lifting mechanism.

### CROSS-REFERENCE TO RELATED APPLICATION

This application claims the benefit of U.S. Provisional Patent Application No. 61/057,729 filed on May 30, 2008.

### FIELD OF THE INVENTION

The invention relates to a lifting mechanism, and more specifically to a lifting mechanism for a green or cured tire including a plurality of extendable arms adapted to facilitate the lifting of the tire.

### BACKGROUND OF THE INVENTION

The manufacture of a pneumatic tire typically includes a plurality of assembly steps bringing together selected rubber, fabric, metallic, and composite components to form a green tire or an uncured tire. The green tire must be cured under a selected combination of temperatures and pressures to cause a cross linking between polymer chains in the rubber to form a final cured tire. The green tire is typically assembled employing one or more assembly or tire building machines, and cured within a tire mold that facilitates a transfer of heat energy into the tire and imparts a desired aesthetic design to at least an outer surface of the final cured tire.

The green tire typically must be lifted and moved during assembly and while positioning the green tire in the tire mold prior to curing. A lifting device is typically employed to lift the green tire. In order to obtain a desired quality of the final cured tire, the tire lifter must minimize a distortion of the tire, and hold the tire in a desired position in respect of the tire lifter to facilitate an accurate positioning of the tire on the tire building machine and in the tire mold.

It would be desirable to have a tire lifting mechanism adapted to lift a tire while minimizing a distortion thereof and facilitating an accurate positioning of the tire in respect of selected tire manufacturing equipment.

### SUMMARY OF THE INVENTION

Compatible and attuned with the present invention, a tire lifting mechanism adapted to lift a green or cured tire while minimizing a distortion thereof and facilitating an accurate positioning of the tire in respect of selected tire manufacturing equipment, has surprisingly been discovered.

The above objective, as well as others, may be achieved by a lifting mechanism comprising a frame having a plurality of extendable arms adapted to be received in an opening of an article; and means for causing the arms to extend and engage the article adjacent the opening to facilitate lifting and centering the article upon an upward movement of the frame.

### BRIEF DESCRIPTION OF THE DRAWINGS

The above, as well as other objects and advantages of the invention, will become readily apparent to those skilled in the art from the following detailed description of an embodiment of the invention when considered in the light of the accompanying figure, in which:

FIG. 1 is an elevation view of the tire lifting mechanism according to an embodiment of the invention; and

FIGS. 2 through 8 are a mechanical drawing illustrating the components of the tire lifting mechanism illustrated in FIG. 1.

### DETAILED DESCRIPTION OF A PREFERRED EMBODIMENT OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

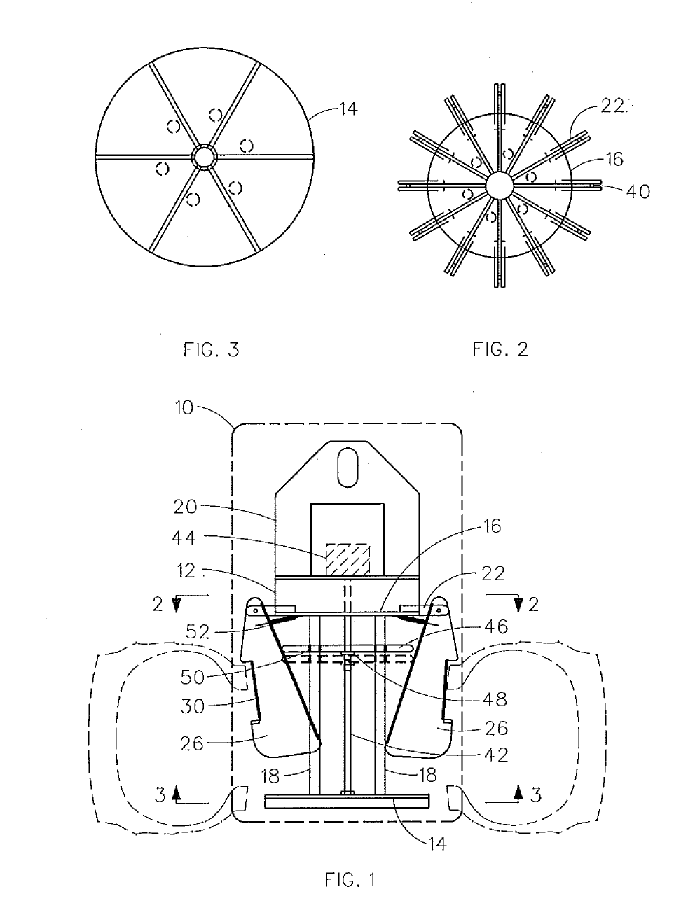

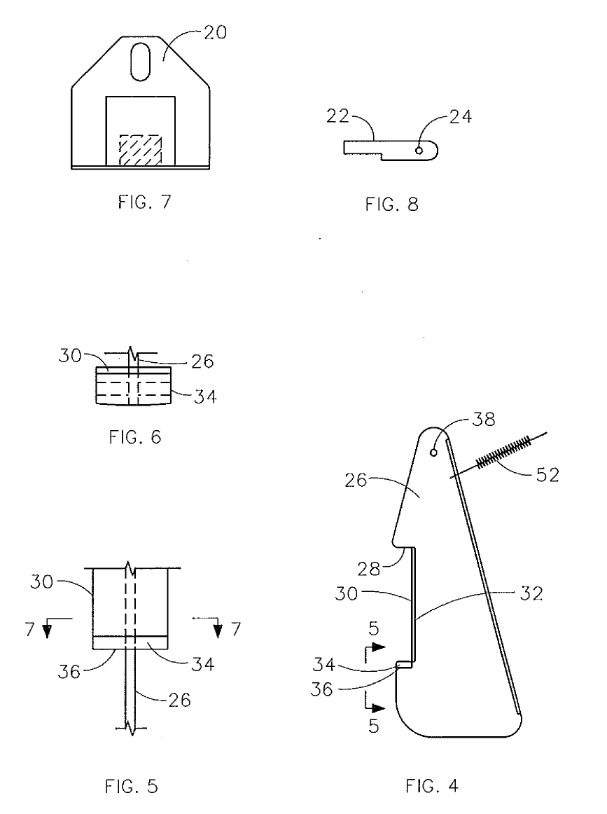

Referring to FIGS. 1 through 8 there is illustrated a tire lifting mechanism 10. The mechanism 10 includes a frame 12 having a lower plate 14 and a spaced apart upper plate assembly 16 in substantial alignment. In the illustrated embodiment, the plates 14, 16 have a generally circular shape. A plurality of tubes or columns 18 are disposed between the plates 14, 16 and attached thereto. The tubes 18 are adapted to maintain the spaced apart relation of the plates 14, 16. In the illustrated embodiment the tubes 18 are attached to the plates 14, 16 employing a welding process. It should be understood that other means may be employed to attach the tubes 18 to the plates 14, 16 such as a mechanical fastener for example.

One lifting lug 20 is disposed on an upper surface of the frame 12. The lug 20 is adapted to facilitate an attachment of the lifting device 10 to an associated mechanism such as a hoist, a hydraulic or pneumatic lifting mechanism, a tire building machine, or tire curing press, for example.

A plurality of elongate members 22 are attached to the plate assembly 16 adjacent an outer edge thereof. An end of the elongate members 22 extends radially outwardly from the outer edge of the plate assembly 16 and includes an aperture 24 therethrough. In the illustrated embodiment, twelve elongate members 22 are attached to the plate assembly 16 in a substantially radial configuration wherein the elongate members 22 are spaced apart by about 30 degrees. However, it should be understood that fewer or additional elongate members 22 can be used as desired.

An arm 26 is pivotally attached to each of the elongate members 22. The arm 26 has a general shape of a right triangle having a long edge or a hypotenuse edge facing inwardly toward the center of the plate assembly 16. An outer edge of the arm 26 includes a notch 28 formed therein. A plate 30 is attached to a back surface 32 of the notch 28, and a plate 34 is attached to a lower edge 36 of the notch 28. The plates 30, 34 provide a surface adapted to contact and support the tire to be lifted by the lifting mechanism 10. The arm 26 includes an aperture 38 formed therein adapted to cooperate with aperture 24 of the elongate member 22 and an associated fastener 40 to pivotally connect the arm 26 to the elongate member 22.

A threaded screw 42 is rotatably attached to the plate 14 at one end and extends upwardly therefrom through the upper plate assembly 16. The opposite end of the threaded screw is connected to means for rotating the screw 42 about its longitudinal axis. In the illustrated embodiment, the means for rotating is an electrical motor 44. However, it should be understood that other means may be employed to rotate the screw 42 such as a hydraulic or pneumatic means, for example.

A movable plate 46 having a generally circular shape is provided having a threaded aperture 48 therethrough. The aperture 48 is located substantially at the center of the plate 46 and adapted to receive the threaded screw 42. The plate 46 includes a plurality of apertures 50 adapted to slidably receive the tubes 18, wherein the tubes 18 and the apertures 50 substantially prevent a rotation of the movable plate 46 in respect of the frame 12. The movable plate 46 is adapted to move upwardly toward the upper plate assembly 16 upon a rotation of the threaded screw 42 in one direction, and downwardly toward the plate 14 upon a rotation of the threaded screw 42 in an opposite direction. An outer edge of the movable plate 46 is adapted to contact the long edge of the arm 26.

A spring 52 is attached at one end to the upper plate assembly 16 and at an opposite end to the arm 26. The spring 52 is adapted to bias the arm 26 in a position that substantially maintains contact between the outer edge of the movable plate 46 and the long edge of the arm 26. It is understood that the thread screw 42, the motor 44, the moveable plate 46, and the spring 52 may form an engaging assembly for causing the arms 26 to extend and engage a tire to facilitate lifting the tire upon an upward movement of the frame 12. However, other devices and mechanisms may be used to form the engaging assembly.

In use, the lifting mechanism 10 is employed to lift a tire adjacent the area of the annular bead of the tire. The movable plate 46 is positioned adjacent the upper plate assembly 16 to cause the arms 26 to be in a retracted position as shown in FIG. 1. The lifting mechanism 10 is caused to be received within the annular opening of the tire to position the annular bead of the tire adjacent the notch 28 formed in the arm 26. The means for rotating 44 the screw 42 is energized causing the screw 42 to rotate and move the movable plate 46 downwardly toward the plate 14. As the movable plate 46 moves downwardly, the outer edge of the movable plate 46 slidably contacts the long edge of the arms 26 causing the arms 26 to extend radially outwardly from the frame 12. It should be understood that a wear resistant member such as a brass member may be disposed on the long edge of the arm 26 and/or the outer edge of the movable plate 46 to minimize a wear of the long edge of the arm 26 and/or the outer edge of the movable plate 46.

Simultaneous to the movement of the movable plate 46, the lifting mechanism is drawn upwardly in respect of the tire to position the bead area thereof against the plates 30, 34 disposed in the notch 28 of the arms 26 having the plate 36 positioned on an underside of the tire bead area, Upon the desired positioning of the bead area against the plates 30, 34, the rotation of the screw 42 is stopped. The lifting mechanism is continued to be drawn upwardly to lift the tire from a supporting surface wherein the tire is suspended from the underside of the bead area of the tire by the plate 34 of the lifting mechanism 10. It should be understood that one or more sensors and/or controllers such as position sensors, torque sensors, PLC controllers, and the like may be employed to control and/or monitor the means for rotating the screw, the position of the arms, and the upward and downward motion of the lifting mechanism 10.

The mechanism to which the lifting mechanism 10 is attached can then be employed to move the lifting mechanism 10 having the tire suspended therefrom to a desired location. The tire can then be placed in the desired location by operating the lift mechanism 10 in the reverse order as described for the lifting of the tire.

The lifting mechanism 10 is adapted to lift a tire while minimizing a distortion thereof and facilitating an accurate positioning of the tire in respect of selected tire manufacturing equipment herein. In particular the structure of the arms 26 and the movable plate 46 substantially center the tire on the lifting mechanism 10 which facilitates the accurate placement of the tire in a desired location in respect to a tire building machine or a tire mold, for example.

The lifting mechanism 10 has been found to be useful for the lifting of large off-the-road tires such as those used for mining equipment which can weigh as much as 15,000 pounds or more. However, it should be understood that the lifting mechanism 10 can be adapted to lift other tires such as standard automobile tires or tires for farm equipment, for example, or any other similar parts.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A lifting mechanism comprising:
a frame having a plurality of extendable arms adapted to be received in an opening of an article; and
an engaging assembly for causing the arms to extend and engage the article adjacent the opening to facilitate lifting the article upon an upward movement of the frame.

2. The lifting mechanism according to claim 1, wherein the frame is substantially centered in the opening of the article.

3. The lifting mechanism according to claim 1, wherein the arms have a substantially triangular shape.

4. The lifting mechanism according to claim 1, wherein each of the arms includes a notch formed therein for receiving and securing the article.

5. The lifting mechanism according to claim 1, wherein the article is at least one of a green and a cured tire.

6. The lifting mechanism according to claim 1, further comprising a lifting lug disposed on an upper surface of the frame.

7. A lifting mechanism comprising:
a frame having a lower plate and an upper plate assembly;
a plurality of extendable arms coupled to the frame and adapted to be received in an opening of an article;
an engaging assembly for causing the arms to extend and engage the article adjacent the opening to facilitate lifting the article upon an upward movement of the frame.

8. The lifting mechanism according to claim 7, wherein the frame is substantially centered in the opening of the article.

9. The lifting mechanism according to claim 7, wherein the arms have a substantially triangular shape.

10. The lifting mechanism according to claim 7, wherein each of the arms includes a notch formed therein for receiving and securing the article.

11. The lifting mechanism according to claim 7, wherein the article is at least one of a green and a cured tire.

12. The lifting mechanism according to claim 11, further comprising a lifting lug disposed on an upper surface of the frame.

13. A lifting mechanism comprising:
a frame having a lower plate and an upper plate assembly;
a plurality of extendable arms coupled to the frame and adapted to be received in an opening of an article;
a threaded screw rotatably attached to the frame; and
a moveable plate having a threaded aperture for receiving the threaded screw, wherein a rotation of the screw causes the moveable plate to engage and extend the arms, thereby engaging the article adjacent the opening to facilitate lifting the article upon an upward movement of the frame.

14. The lifting mechanism according to claim 13, wherein the frame is substantially centered in the opening of the article.

15. The lifting mechanism according to claim 13, wherein the arms have a substantially triangular shape.

16. The lifting mechanism according to claim 13, wherein each of the arms includes a notch formed therein for receiving and securing the article.

17. The lifting mechanism according to claim 13, wherein the article is at least one of a green and a cured tire.

18. The lifting mechanism according to claim 18, further comprising a lifting lug disposed on an upper surface of the frame.
